(19) United States
(12) Patent Application Publication
(10) Pub. No.: US 2002/0125685 A1
(43) Pub. Date: Sep. 12, 2002

(54) Trailer hitch alignment system

(76) Inventor: Roger P. White, Stirum, ND (US)

Correspondence Address: Michael S. Neustel, Suite No. 4, 2534 South University Drive, Fargo, ND, 58103, US

(21) Appl. No.: 09/756,973

(22) Filed: Jan. 9, 2001

(51) Int. Cl. B60D 1/01

(52) U.S. Cl. 280/504

(57) ABSTRACT

A trailer hitch alignment system for allowing a user to easily align a hitch of a vehicle with a trailer hitch. The trailer hitch alignment system includes a magnetic base, a hinge attached to the magnetic base, a coil spring attached to the hinge, a telescoping shaft attached to the coil spring, and an indicator attached to the distal end of the telescoping shaft. The indicator preferably is comprised of a spherical structure having one or more reflective strips positioned thereupon. The hinge preferably includes a wing nut compressing a compression spring for allowing adjustment of the frictional engagement of the hinge. The user utilizes two of the trailer hitch alignment devices wherein one is attached to the hitch and the other to the bumper of the vehicle with the respective indicator of each properly aligned.

### BACKGROUND OF THE INVENTION

1. Field of the Invention

The present invention relates generally to trailer hitch alignment devices and more specifically it relates to a trailer hitch alignment system for allowing a user to easily align a hitch of a vehicle with a trailer hitch.

Users of trailers often have great difficulty in aligning their vehicle's hitch with the trailer hitch of a conventional trailer. The user must back up slowly and repeatedly stop the vehicle and exit the vehicle to determine the new location of the hitch with respect to the trailer hitch so as to not damage the vehicle. This is undesirable for user's who utilize trailers often such as farmers. Hence, there is a need for a trailer hitch alignment system that allows a user to conveniently align a vehicle with a trailer hitch without the user having to exit the vehicle.

2. Description of the Prior Art

Trailers have been in use for years. Typically, a trailer has a plurality of wheels rotatably supporting a frame and a trailer hitch for removably coupling with a vehicle that will be towing the conventional trailer. The user must align the ball hitch of the vehicle with the raised trailer hitch. This is extremely difficult since the ball hitch is usually out of viewing because of its location upon the vehicle's bumper. The user must then slowly back up to the trailer hitch so as to prevent damage to the vehicle and trailer. The user must also repeatedly exit and enter the vehicle so as to allow viewing of the position of the ball hitch with respect to the trailer hitch. This is continued until the ball hitch is directly beneath the ball coupler of the trailer hitch.

The repeated exiting and entering the vehicle is undesirable for most users. In addition, the constant exiting and entering of the vehicle is time consuming and dangerous for the user. Another problem is that vehicle and trailer damage are almost inevitable over a period of time.

Examples of patented trailer alignment devices which are illustrative of such prior art include U.S. Pat. No. 5,113,588 to Walston; U.S. Pat. No. 5,290,056 to Fath, IV; U.S. Pat. No. 4,627,634 to Coleman; U.S. Pat. No. 5,269,554 to Law et al.; U.S. Pat. No. 5,335,930 to Tighe; U.S. Pat. No. 5,558,352 to Mills; U.S. Pat. No. 5,669,621 to Lockwood; U.S. Pat. No. 5,224,270 to Burrus; U.S. Pat. No. 5,035,441 to Murray; U.S. Pat. No. 4,708,359 to Davenport; U.S. Pat. No. 5,927,229 to Karr, Jr.

While these devices may be suitable for the particular purpose to which they address, they are not as suitable for allowing a user to easily align a hitch of a vehicle with a trailer hitch. Conventional devices and methods do not accurately determine the location of the vehicle with respect to the trailer hitch thereby leading to significant damage to the vehicle and the trailer.

In these respects, the trailer hitch alignment system according to the present invention substantially departs from the conventional concepts and designs of the prior art, and in so doing provides an apparatus primarily developed for the purpose of allowing a user to easily align a hitch of a vehicle with a trailer hitch.

### SUMMARY OF THE INVENTION

In view of the foregoing disadvantages inherent in the known types of trailer hitch alignment devices now present in the prior art, the present invention provides a new trailer hitch alignment system construction wherein the same can be utilized for allowing a user to easily align a hitch of a vehicle with a trailer hitch.

The general purpose of the present invention, which will be described subsequently in greater detail, is to provide a new trailer hitch alignment system that has many of the advantages of the trailer hitch alignment devices mentioned heretofore and many novel features that result in a new trailer hitch alignment system which is not anticipated, rendered obvious, suggested, or even implied by any of the prior art trailer hitch alignment devices, either alone or in any combination thereof.

To attain this, the present invention generally comprises a magnetic base, a hinge attached to the magnetic base, a coil spring attached to the hinge, a telescoping shaft attached to the coil spring, and an indicator attached to the distal end of the telescoping shaft. The indicator preferably is comprised of a spherical structure having one or more reflective strips positioned thereupon. The hinge preferably includes a wing nut compressing a compression spring for allowing adjustment of the frictional engagement of the hinge. The user utilizes two of the trailer hitch alignment devices wherein one is attached to the hitch and the other to the bumper of the vehicle with the respective indicator of each properly aligned.

There has thus been outlined, rather broadly, the more important features of the invention in order that the detailed description thereof may be better understood, and in order that the present contribution to the art may be better appreciated. There are additional features of the invention that will be described hereinafter and that will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of the description and should not be regarded as limiting.

A primary object of the present invention is to provide a trailer hitch alignment system that will overcome the shortcomings of the prior art devices.

A second object is to provide a trailer hitch alignment system for allowing a user to easily align a hitch of a vehicle with a trailer hitch.

An additional object is to provide a trailer hitch alignment system that reduces the number of times the user must exit the vehicle during attachment of a vehicle to a conventional trailer.

A further object is to provide a trailer hitch alignment system that visually indicates the position of the vehicle ball hitch with respect to the conventional trailer such as but not limited to boat trailers, livestock trailers, fifth wheel trailers, and car trailers.

Another object is to provide a trailer hitch alignment system that does not utilize electronic devices, switches or cables for the alignment process.

An additional object is to provide a trailer hitch alignment system that can be easily removed for utilization upon multiple trailers.

Another object is to provide a trailer hitch alignment system that can be utilized as an emergency marker for a vehicle in distress.

An additional object is to provide a trailer hitch alignment system that is simple to utilize for most individuals.

Other objects and advantages of the present invention will become obvious to the reader and it is intended that these objects and advantages are within the scope of the present invention.

To the accomplishment of the above and related objects, this invention may be embodied in the form illustrated in the accompanying drawings, attention being called to the fact, however, that the drawings are illustrative only, and that changes may be made in the specific construction illustrated and described within the scope of the appended claims.

### BRIEF DESCRIPTION OF THE DRAWINGS

Various other objects, features and attendant advantages of the present invention will become fully appreciated as the same becomes better understood when considered in conjunction with the accompanying drawings, in which like reference characters designate the same or similar parts throughout the several views, and wherein:

FIG. 1 is an upper perspective view of the present invention.

FIG. 2 is a top view of the present invention attached to a trailer hitch and a bumper of a vehicle.

FIG. 3 is a top view of the present invention attached to a trailer hitch and a bumper of a vehicle with the indicators aligned.

FIG. 4 is a side view of the present invention.

FIG. 5 is a side view of the present invention illustrating the pivotal movement of the telescoping shaft.

FIG. 6 is a front view of the present invention with the telescoping shaft in a compact position.

FIG. 7 is a front view of the present invention with the telescoping shaft in the extended position.

FIG. 8 is a side view of the present invention attached to a trailer hitch and a bumper of a vehicle.

FIG. 9 is a side view of an alternative embodiment of the present invention illustrating the usage of a hook and loop fastener to secure to non-metallic surfaces.

### DESCRIPTION OF THE PREFERRED EMBODIMENT

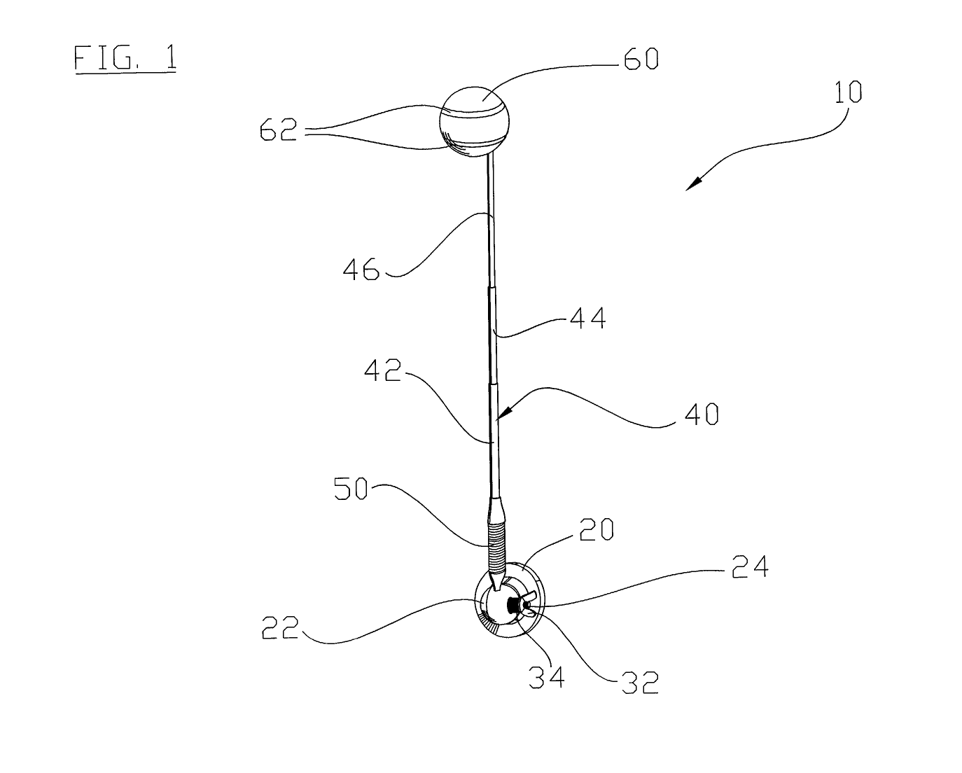

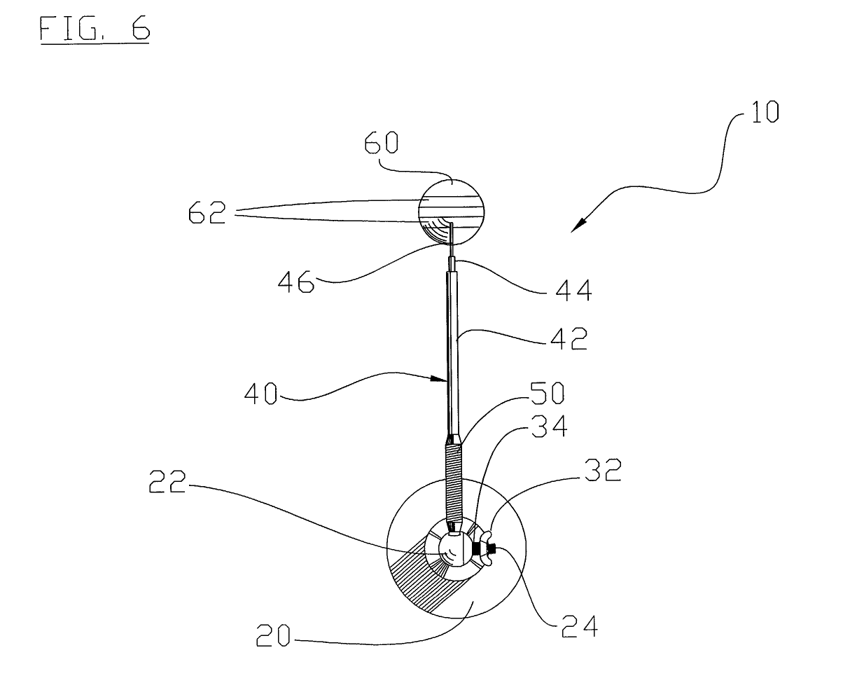

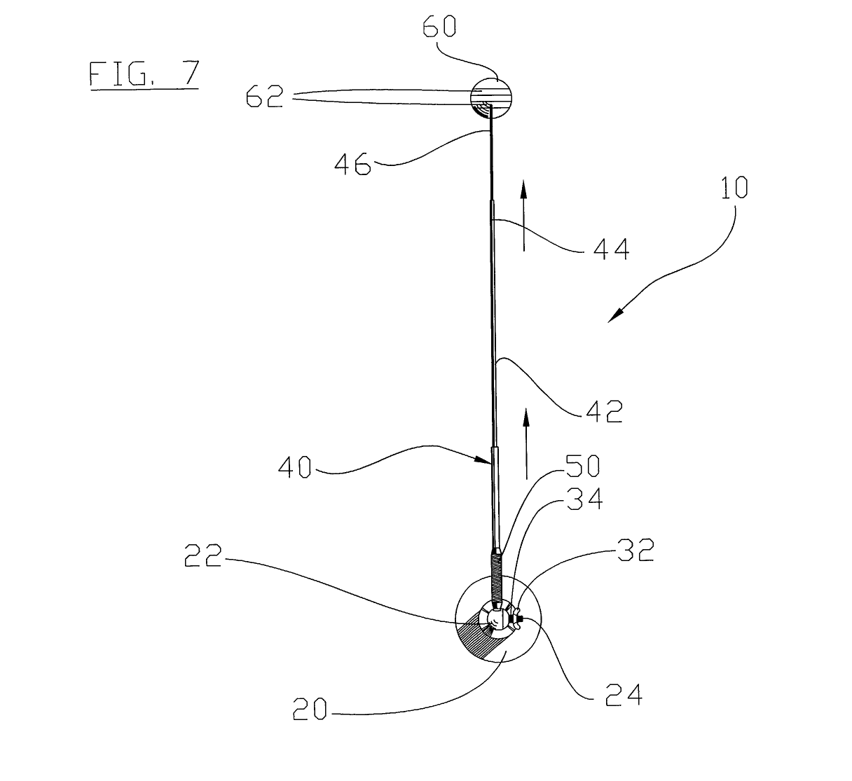

Turning now descriptively to the drawings, in which similar reference characters denote similar elements throughout the several views, FIGS. 1 through 9 illustrate a trailer hitch alignment system 10, which comprises a magnetic base 20, a hinge 30 attached to the magnetic base 20, a coil spring 50 attached to the hinge 30, a telescoping shaft 40 attached to the coil spring 50, and an indicator 60 attached to the distal end of the telescoping shaft 40. The indicator 60 preferably is comprised of a spherical structure having one or more reflective strips 62 positioned thereupon. The hinge 30 preferably includes a wing nut 32 compressing a compression spring 34 for allowing adjustment of the frictional engagement of the hinge 30. The user utilizes two of the trailer 16 hitch 18 alignment devices wherein one is attached to the hitch 18 and the other to the bumper 14 of the vehicle 12 with the respective indicator 60 of each properly aligned.

As shown in FIGS. 1 through 9 of the drawings, a base 20 is provided with the present invention. The base 20 may have any shape and structure as can be appreciated by one skilled in the art. The base 20 preferably includes or is constructed of a magnet material to provide securing to a metal object or surface such as the hitch 18 of a trailer 16 or a bumper 14 of a vehicle 12. The base 20 includes sufficient magnetic material to support the telescoping shaft 40 in a substantially horizontal position when attached to a metal object.

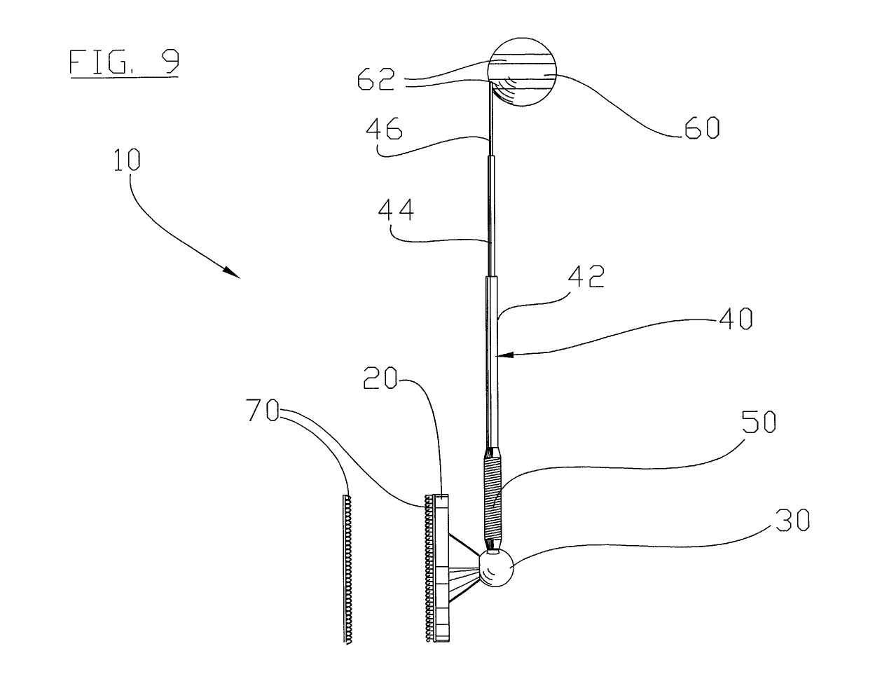

As shown in FIG. 9 of the drawings, the base 20 may also include a hook and loop fastener 70 attached to the face thereof for securing to non-metallic surfaces such as plastic, rubber and fiberglass. The hook and loop fastener 70 is attached to the surface of the vehicle 12 that is not comprised of metal and the opposing portion of the hook and loop fastener 70 is attached to the base 20 thereby allowing integrating of the hook and loop fastener 70.

As best shown in FIGS. 1, 6 and 7 of the drawings, the base 20 includes a bracket 22 extending outwardly. The hinge 30 includes a threaded shaft 24 extending from thereof. The threaded shaft 24 extends outwardly to rotatably receive said bracket 22 as further shown in FIGS. 1, 6 and 7 of the drawings. A compression spring 34 preferably surrounds the exposed portion of the threaded shaft 24 as best illustrated in FIG. 1 of the drawings. A wing nut 32 or other fastener device is threadably attached to the threaded shaft 24 for allowing compression of the compression spring 34 upon the bracket thereby providing an adjustable resistance upon the hinge 30.

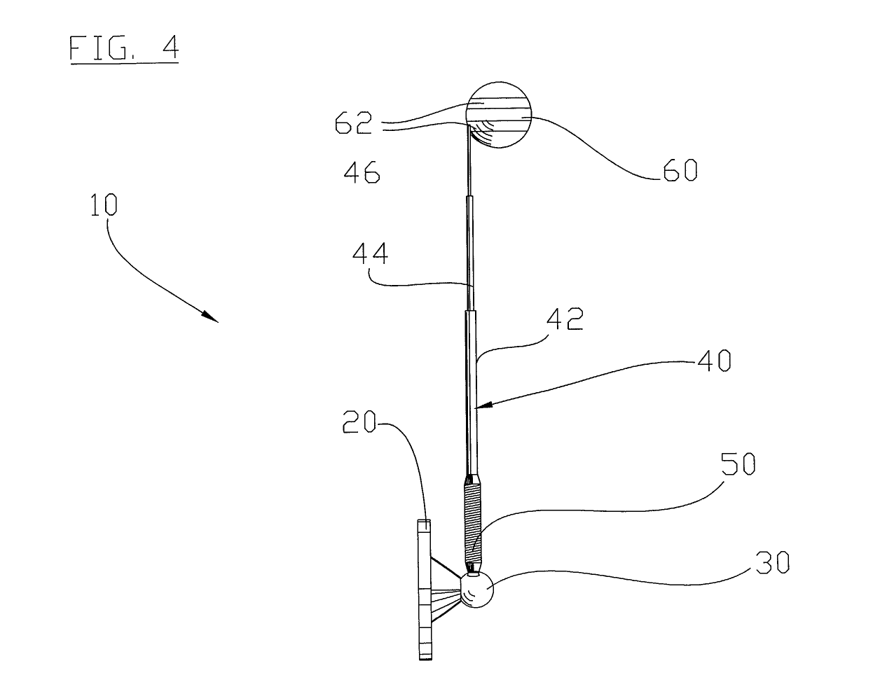

A coil spring 50 is preferably attached to the hinge 30 as best illustrated in FIG. 4 of the drawings. The coil spring 50 is preferable comprised of a spring material sufficient to allow bending when the telescoping shaft 40 encounters an obstacle. As further shown in FIG. 4 of the drawings, the telescoping shaft 40 is preferably attached to the distal end of the coil spring 50. However, it can be appreciated that the telescoping shaft 40 may be directly attached to the hinge 30 without utilizing the coil spring 50.

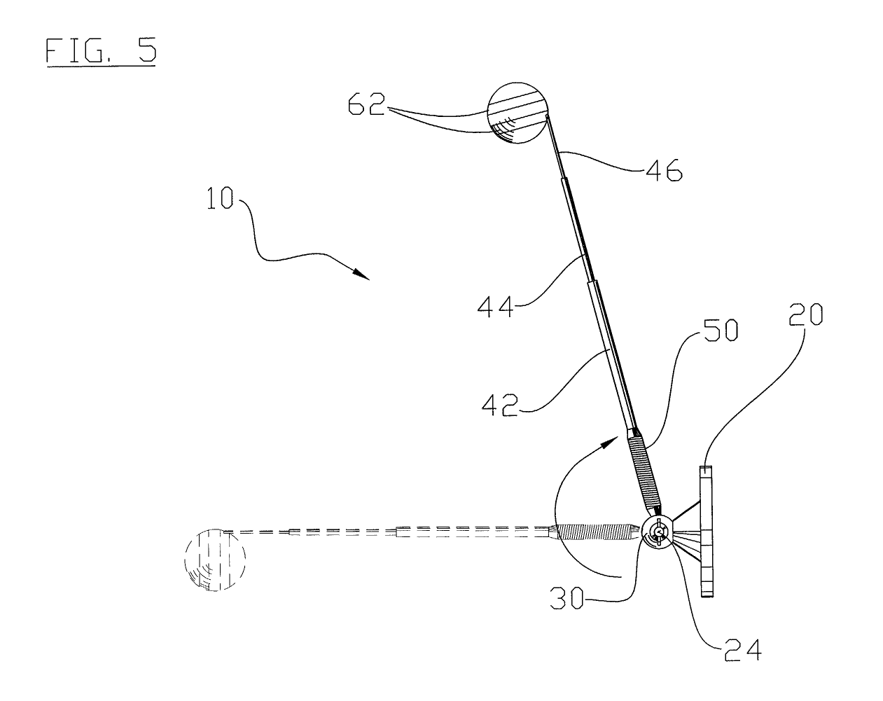

As best shown in FIGS. 1, 4, 5, 6, 7 and 9 of the drawings, the telescoping shaft 40 is comprised of a plurality of portions that are slidably positioned within one another to provide for various adjustable lengths for the telescoping shaft 40. The telescoping shaft 40 preferably includes a first portion 42 attached to the distal portion of the coil spring 50 or the hinge 30 as best shown in FIG. 5 of the drawings. The telescoping shaft 40 further includes a second portion 44 slidably positioned within the first portion 42 as further illustrated in FIG. 5 of the drawings. The telescoping shaft 40 further includes a third portion 46 slidably positioned within the second portion 44 as further illustrated in FIG. 5 of the drawings. It can be appreciated that the telescoping shaft 40 may have any unlimited number of portions as required.

As shown in FIGS. 1, 4, 5, 6, 7 and 9 of the drawings, the indicator 60 is attached to the distal end of the telescoping shaft 40. The indicator 60 is preferably comprised of a colored material including but not limited to fluorescent colors. The indicator 60 is preferably comprised of a spherical structure as shown in FIG. 1 of the drawings. The indicator 60 may be comprised of additional shapes and sizes as can be appreciated. The telescoping shaft 40 preferably is attached to the indicator 60 off- center for facilitating a downward position of the indicator 60 that is rotatable as best shown in FIG. 4.

As further shown in FIGS. 1, 4, 5, 6, 7 and 9 of the drawings, one or more reflective strips 62 are preferably attached to the outer surface of the indicator 60. The reflective strips 62 provide increased visibility of the indicator 60 during darkness by reflecting the light from the vehicle 12 and adjacent light sources.

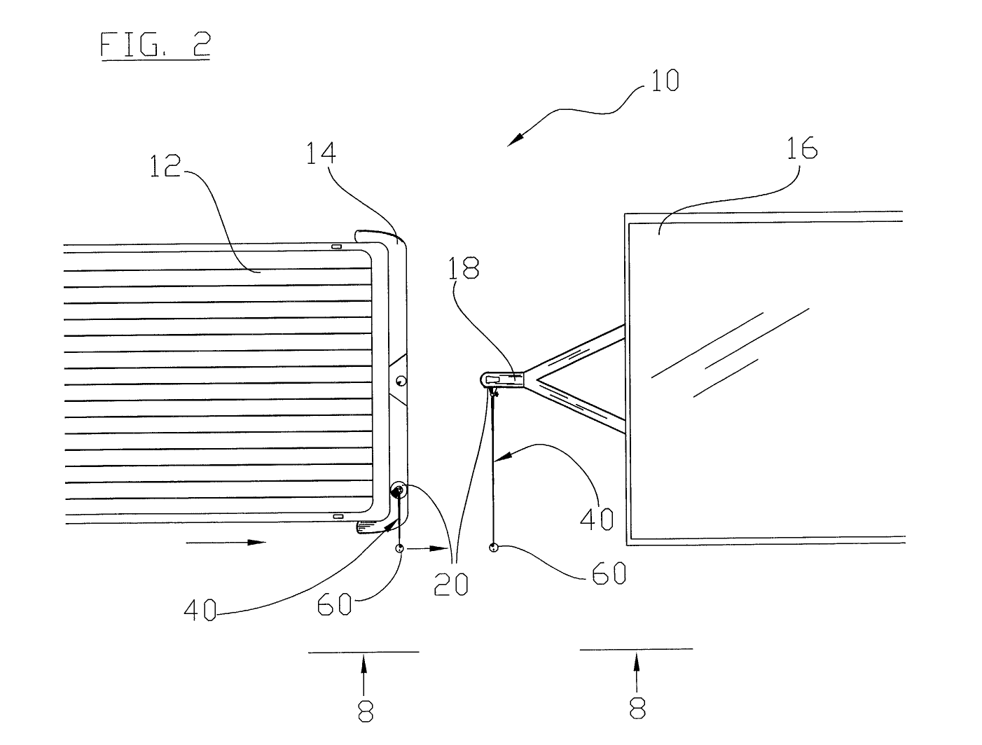

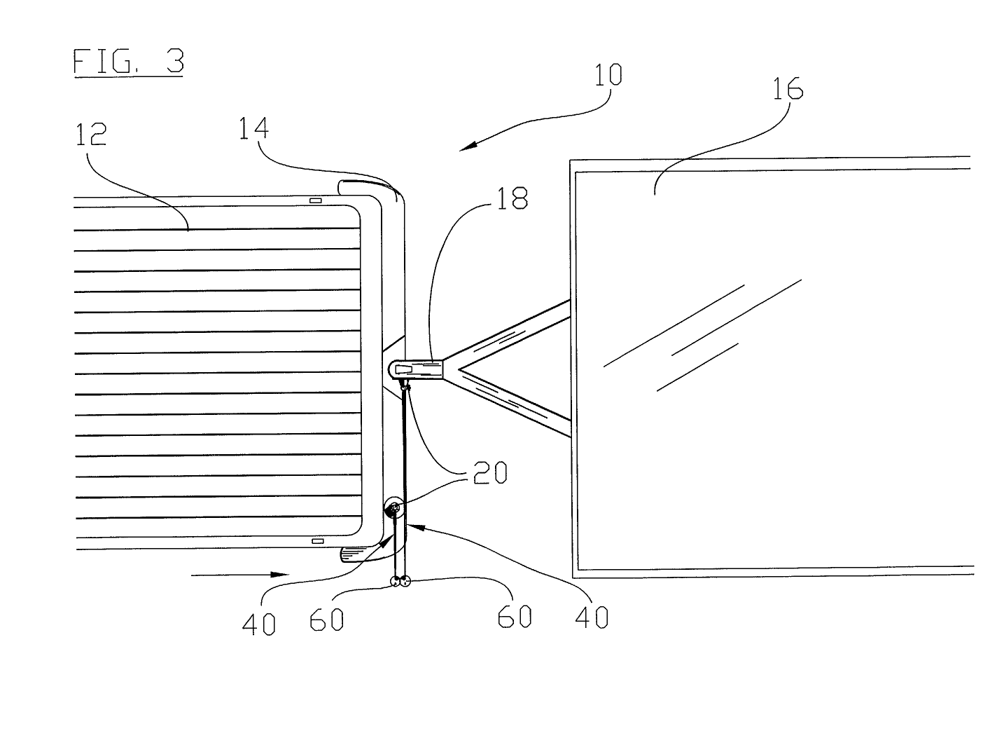

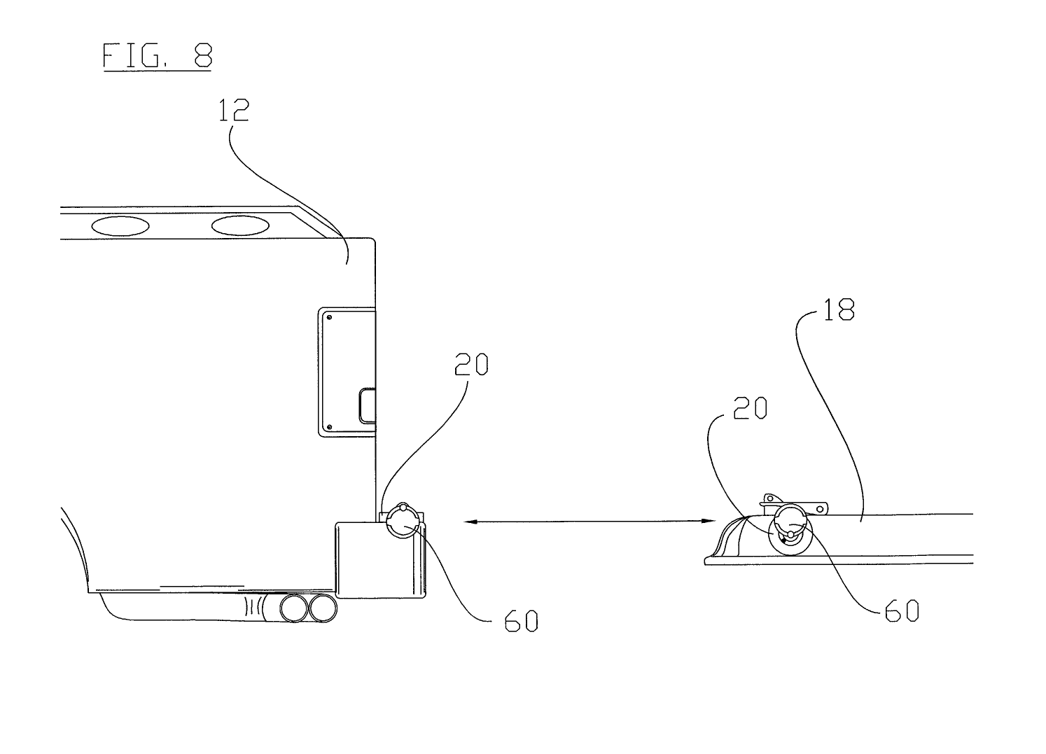

In use, the user secures the base 20 to the hitch 18 of the trailer 16 as best illustrated in FIGS. 2, 3 and 8 of the drawings. The user then secures a second trailer 16 hitch 18 alignment system 10 to the bumper 14 or body of the vehicle 12 as shown in FIGS. 2, 3 and 8 of the drawings. The user ensures that the telescoping shafts 40 are substantially parallel to one another such as in a horizontal position as best shown in FIG. 8 of the drawings. The user then adjusts the respective length of each telescoping shaft 40 to the appropriate length so that each respective indicator 60 is aligned with one another with the rearward movement of the vehicle 12 as shown in FIGS. 2, 3 and 8 of the drawings. If the ball of the vehicle 12 is misaligned with respect to the hitch 18 of the trailer 16, the user simply adjusts the length of the telescoping shaft 40 to accommodate for the initial misalignment of the vehicle 12. The user then moves the vehicle 12 rearwardly toward the hitch 18 of the trailer 16 while monitoring the position of each indicator 60 within their side mirror of the vehicle 12. The user continues to move the vehicle 12 rearwardly until the indicators 60 are adjacent to one another indicating that the hitch 18 is properly positioned above the ball of the bumper 14 of the vehicle 12 as shown in FIG. 3 of the drawings. The user then exits the vehicle 12 and removes each of the trailer 16 hitch 18 alignment systems 10 from the hitch 18 and the vehicle 12 thereafter positioning them in a storage location. If required to be utilized within an emergency situation, the base 20 may be secured to the body or bumper 14 of the vehicle 12 with the telescoping shaft 40 extending substantially vertically to indicate potential vehicle 12 problems.

As to a further discussion of the manner of usage and operation of the present invention, the same should be apparent from the above description. Accordingly, no further discussion relating to the manner of usage and operation will be provided.

With respect to the above description then, it is to be realized that the optimum dimensional relationships for the parts of the invention, to include variations in size, materials, shape, form, function and manner of operation, assembly and use, are deemed to be within the expertise of those skilled in the art, and all equivalent structural variations and relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

Index of Elements for Trailer Hitch Alignment System

| □ | ENVIRONMENTAL |
|---|---|
| | ELEMENTS |
| □ | |
| □ | |
| □ | |
| □ | |
| □ | |
| □ | |
| □ | |
| □ | |
| □ | |
| □ | 10. Trailer Hitch Alignment System |
| □ | 11. |
| □ | 12. Vehicle |
| □ | 13. |
| □ | 14. Bumper |
| □ | 15. |
| □ | 16. Trailer |
| □ | 17. |
| □ | 18. Hitch |
| □ | 19. |
| □ | 20. Magnetic Base |
| □ | 21. |
| □ | 22. Bracket |
| □ | 23. |
| □ | 24. Threaded Shaft |
| □ | 25. |
| □ | 26. |
| □ | 27. |
| □ | 28. |
| □ | 29 |
| □ | 30. Hinge |
| □ | 31. |
| □ | 32. Wing Nut |
| □ | 33. |
| □ | 34. Compression Spring |
| □ | 35. |
| □ | 36. |
| □ | 37. |
| □ | 38. |
| □ | 39. |
| □ | 40. Telescoping Shaft |
| □ | 41. |
| □ | 42. First Portion |
| □ | 43. |
| □ | 44. Second Portion |
| □ | 45. |
| □ | 46. Third Portion |
| □ | 47. |
| □ | 48. |
| □ | 49. |
| □ | 50. Coil Spring |
| □ | 51. |
| □ | 52. |
| □ | 53. |
| □ | 54. |
| □ | 55. |
| □ | 56. |
| □ | 57. |
| □ | 58. |
| □ | 59. |
| □ | 60. Indicator |
| □ | 61. |
| □ | 62. Reflective Strips |
| □ | 63. |
| □ | 64. |
| □ | 65. |
| □ | 66. |
| □ | 67. |
| □ | 68. |
| □ | 69. |
| □ | 70. Hook and Loop Fastener |
| □ | 71. |
| □ | 72. |
| □ | 73. |
| □ | 74. |
| □ | 75. |
| □ | 76. |
| □ | 77. |
| □ | 78. |
| □ | 79. |

I claim:

1. A trailer hitch alignment system, comprising:
a base having a hinge;
a means for attaching said base to a vehicle or hitch;
a telescoping shaft attached to said hinge; and
an indicator attached to a distal end of said telescoping shaft.

2. The trailer hitch alignment system of claim 1, wherein said means for attaching said base to a vehicle or hitch is comprised of at least one magnet.

3. The trailer hitch alignment system of claim 2, wherein said hinge has an adjustable frictional engagement.

4. The trailer hitch alignment system of claim 3, wherein said base includes a bracket, wherein said hinge includes a threaded shaft extending from said hinge rotatably extending through said bracket, and including a wing nut threadably engaged to said threaded shaft.

5. The trailer hitch alignment system of claim 4, including a compression spring positioned about said threaded shaft between said bracket and said wing nut.

6. The trailer hitch alignment system of claim 5, wherein said indicator includes at least one reflective strip.

7. The trailer hitch alignment system of claim 6, wherein said indicator is comprised of a spherical structure.

8. The trailer hitch alignment system of claim 7, wherein said indicator is comprised of a fluorescent color.

9. The trailer hitch alignment system of claim 8, wherein said telescoping shaft includes a first portion attached to said hinge, a second portion slidably positioned within said first portion, and a third portion slidably positioned within said second portion.

10. The trailer hitch alignment system of claim 1, wherein said wherein said means for attaching said base to a vehicle or hitch is comprised of a hook and loop fastener.

11. A trailer hitch alignment system, comprising:
a base having a hinge;
a coil spring attached to said hinge;
a means for attaching said base to a vehicle or hitch;
a telescoping shaft attached to said coil spring; and
an indicator attached to a distal end of said telescoping shaft.

12. The trailer hitch alignment system of claim 11, wherein said means for attaching said base to a vehicle or hitch is comprised of at least one magnet.

13. The trailer hitch alignment system of claim 12, wherein said hinge has an adjustable frictional engagement.

14. The trailer hitch alignment system of claim 13, wherein said base includes a bracket, wherein said hinge includes a threaded shaft extending from said hinge rotatably extending through said bracket, and including a wing nut threadably engaged to said threaded shaft.

15. The trailer hitch alignment system of claim 14, including a compression spring positioned about said threaded shaft between said bracket and said wing nut.

16. The trailer hitch alignment system of claim 15, wherein said indicator includes at least one reflective strip.

17. The trailer hitch alignment system of claim 16, wherein said indicator is comprised of a spherical structure.

18. The trailer hitch alignment system of claim 17, wherein said indicator is comprised of a fluorescent color.

19. The trailer hitch alignment system of claim 18, wherein said telescoping shaft includes a first portion attached to said coil spring, a second portion slidably positioned within said first portion, and a third portion slidably positioned within said second portion.

20. The trailer hitch alignment system of claim 11, wherein said wherein said means for attaching said base to a vehicle or hitch is comprised of a hook and loop fastener.
